(19) United States
(12) Patent Application Publication
(10) Pub. No.: US 2006/0273888 A1
(43) Pub. Date: Dec. 7, 2006

(54) Radio Communication System and Radio Communication Device

(75) Inventor: Hiroya Yamamoto, Gunma-ken (JP)

Correspondence Address: FISH & RICHARDSON P.C., P.O. BOX 1022, MINNEAPOLIS, MN, 55440-1022, US

(73) Assignee: Sanyo Electric Co., Ltd, Osaka (JP)

(21) Appl. No.: 11/383,434

(22) Filed: May 15, 2006

(30) Foreign Application Priority Data
May 16, 2005 (JP) 2005-142385

(51) Int. Cl. B60R 25/10

(52) U.S. Cl. 340/426.36; 340/426.23

(57) ABSTRACT

A radio communication system including a first radio communication device and a second radio communication device. The first radio communication device transmits a first radio signal. The second radio communication device receives the first radio signal. The second radio communication device measures the signal strength of the first radio signal. The second radio communication device transmits the second radio signal containing the signal strength measurement. The first radio communication device receives the second radio signal, and performs first determination of a distance between the first and second radio communication devices based on the signal strength measurement contained in the received second radio signal.

### CROSS-REFERENCE TO RELATED APPLICATIONS

The present application claims priority from Japanese Patent Application No. 2005-142385 filed on May 16, 2005, which is herein incorporated by reference.

### BACKGROUND OF THE INVENTION

1. Field of the Invention

The present invention relates to a radio communication system and a radio communication device capable of realizing a keyless entry system that is high in security.

2. Description of the Related Art

There are keyless entry systems that enable locking/unlocking of the doors of vehicles by remote operation via a mobile device being carried by carriers such as the users of the vehicles. Furthermore, there are smart entry systems that lock/unlock doors without the operation of a mobile device. Japanese Patent Application Laid-Open Publication No. H05-106376 describes a keyless entry system having a vehicle-mounted radio device (hereinafter called a vehicle-mounted device) and a mobile radio device (hereinafter called a mobile device), wherein the vehicle-mounted device transmits a code request signal at given time intervals, and the mobile device receives the code request signal and transmits a return code and wherein when receiving the return code, the vehicle-mounted device outputs a signal to unlock the doors of the vehicle and, if receiving no return code at all, after a predetermined time elapses, outputs a signal to lock the doors of the vehicle. Moreover, Japanese Patent Application Laid-Open Publication No. S63-1765 describes technology in which to transmit a call signal to a mobile device, receive an identification code signal from the mobile device, match this identification code signal against an internal code and, if matching, allow the unlocking of a steering lock mechanism, the switching of an ignition switch, the switching of an accessory switch, etc.

Used as a radio wave on which to transmit the code request signal is a radio wave having a relatively narrow reaching range (e.g., a wave of a frequency in a long wave (LF) band) so that the doors of the vehicle are not unlocked while the carrier is away from the vehicle.

In these days, a so-called relay attack is known as a tactic for the theft of vehicles, wherein, as shown in FIG. 19, a separately prepared radio communication device (hereinafter called a relay unit X) is installed near a vehicle-mounted device 1 and another radio communication device (hereinafter called a relay unit Y) is installed near a mobile device 2 and wherein by having the communication between the relay units X and Y relay the communication between the vehicle-mounted device 1 and the mobile device 2, its doors are unlocked or its engine is started while the carrier is away from the vehicle. Accordingly, the smart keyless entry system needs to be provided with a mechanism for preventing such a tactic. For example, Japanese Patent Application Laid-Open Publication No. 2004-19381 discloses that the mobile device notifies its having sent a return code to the carrier via a buzzer.

### SUMMARY OF THE INVENTION

The present invention was made in view of the above background, and an object thereof is to provide a radio communication system and radio communication device capable of realizing a keyless entry system that is high in security.

According to a main aspect of the present invention to achieve the above object, there is provided a radio communication system comprising a first radio communication device including a CPU; a memory; a transmitter that transmits a first radio signal; and a receiver that receives a second radio signal; and a second radio communication device including a CPU; a memory; a transmitter that transmits the second radio signal; a receiver that receives the first radio signal; and a signal strength measuring section that measures a signal strength of the first radio signal, wherein the first radio communication device transmits the first radio signal, the second radio communication device receives the first radio signal, the second radio communication device measures the signal strength of the first radio signal, the second radio communication device transmits the second radio signal containing the signal strength measurement, the first radio communication device receives the second radio signal, and the first radio communication device performs first determination of a distance between the first and second radio communication devices based on the signal strength measurement contained in the received second radio signal.

As such, in the present invention, the second radio communication device measures the signal strength of the first radio signal transmitted by the first radio communication device. The distance between the first and second radio communication devices is determined based on the measured signal strength. Hence, the distance between the first and second radio communication devices can be reliably determined. Performing this determination improves security against relay attacks.

According to another main aspect of the present invention, there is provided a radio communication system comprising:

a first radio communication device including a CPU; a memory; a transmitter that transmits a first radio signal; and a receiver that receives a second radio signal; and a second radio communication device including a CPU; a memory; a transmitter that transmits the second radio signal; a receiver that receives the first radio signal; and a signal strength measuring section that measures a signal strength of the first radio signal, wherein the first radio communication device transmits the first radio signal, the second radio communication device receives the first radio signal, the second radio communication device measures the signal strength of the first radio signal, the second radio communication device transmits the second radio signal containing the signal strength measurement, the first radio communication device receives the second radio signal, the first radio communication device performs first determination of a distance between the first and second radio communication devices based on the signal strength measurement contained in the received second radio signal, the first radio communication device transmits a third radio signal, the second radio communication device receives the third radio signal, the second radio communication device transmits a fourth radio signal in response to receiving the third radio signal, the first radio communication device receives the fourth radio signal, the first radio communication device performs second determination of the distance between the first and second radio communication devices based on an elapsed time from transmitting the third radio signal to receiving the fourth radio signal, and the first radio communication device performs third determination of the distance between the first and second radio communication devices based on a result of the first determination and on a result of the second determination.

As such, in the present invention, the second radio communication device (e.g., a mobile device) measures the signal strength of the first radio signal transmitted by the first radio communication device (e.g., a vehicle-mounted device), and the first radio communication device performs first determination of the distance between the first and second radio communication devices based on the signal strength measurement. Further, the first radio communication device determines the distance between the first and second radio communication devices based on the elapsed time from transmitting the third radio signal to receiving the fourth radio signal returned by the second radio communication device, and finally determines the distance between the first and second radio communication devices based on a result of the first determination and on a result of the second determination. Hence, the distance between the first and second radio communication devices can be reliably determined. Performing this determination improves security against relay attacks.

Features and objects of the present invention other than the above will become apparent from the description of this specification and the accompanying drawings.

### BRIEF DESCRIPTION OF THE DRAWINGS

For a more complete understanding of the present invention and the advantages thereof, reference is now made to the following description taken in conjunction with the accompanying drawings wherein:

FIG. 1 is a diagram showing schematically the configuration of a smart keyless entry system 100 according to an implementation of the present invention;

FIG. 2 is a diagram showing the hardware configuration of a vehicle-mounted device 1 according to a first implementation of the present invention;

FIG. 3 is a diagram showing the hardware configuration of a mobile device 2 according to the first implementation of the present invention;

FIG. 4 is a diagram showing an example of an RSSI circuit 28 according to an implementation of the present invention;

FIG. 5A is a flow chart for explaining the operation of the smart keyless entry system 100 according to the first implementation of the present invention;

FIG. 5B is a flow chart for explaining the operation of the smart keyless entry system 100 according to the first implementation of the present invention;

FIG. 6 is a timing chart for explaining the operation of the smart keyless entry system 100 according to the first implementation of the present invention;

FIG. 7 is a diagram showing the hardware configuration of a vehicle-mounted device 1 according to a second implementation of the present invention;

FIG. 8 is a diagram showing the hardware configuration of a mobile device 2 according to the second implementation of the present invention;

FIG. 9A is a flow chart for explaining the operation of the smart keyless entry system 100 according to the second implementation of the present invention;

FIG. 9B is a flow chart for explaining the operation of the smart keyless entry system 100 according to the second implementation of the present invention;

FIG. 9C is a flow chart for explaining the operation of the smart keyless entry system 100 according to the second implementation of the present invention;

FIG. 10 is a timing chart for explaining the operation of the smart keyless entry system 100 according to the second implementation of the present invention;

FIG. 11 is a diagram showing the hardware configuration of a vehicle-mounted device 1 according to a third implementation of the present invention;

FIG. 12 is a diagram showing the hardware configuration of a mobile device 2 according to the third implementation of the present invention;

FIG. 13A is a flow chart for explaining the operation of the smart keyless entry system 100 according to the third implementation of the present invention;

FIG. 13B is a flow chart for explaining the operation of the smart keyless entry system 100 according to the third implementation of the present invention;

FIG. 14 is a timing chart for explaining the operation of the smart keyless entry system 100 according to the third implementation of the present invention;

FIG. 15 is a diagram showing the hardware configuration of a vehicle-mounted device 1 according to a fourth implementation of the present invention;

FIG. 16 is a diagram showing the hardware configuration of a mobile device 2 according to the fourth implementation of the present invention;

FIG. 17A is a flow chart for explaining the operation of the smart keyless entry system 100 according to the fourth implementation of the present invention;

FIG. 17B is a flow chart for explaining the operation of the smart keyless entry system 100 according to the fourth implementation of the present invention;

FIG. 17C is a flow chart for explaining the operation of the smart keyless entry system 100 according to the fourth implementation of the present invention;

FIG. 18 is a timing chart for explaining the operation of the smart keyless entry system 100 according to the fourth implementation of the present invention; and

FIG. 19 is a diagram for explaining a relay attack tactic.

### DETAILED DESCRIPTION OF THE INVENTION

At least the following matters will be made clear by the explanation in the present specification and the description of the accompanying drawings.

Several implementations of the present invention will be described below in detail. In the description below, a smart keyless entry system 100 will be described as an example of a radio communication system according to the invention.

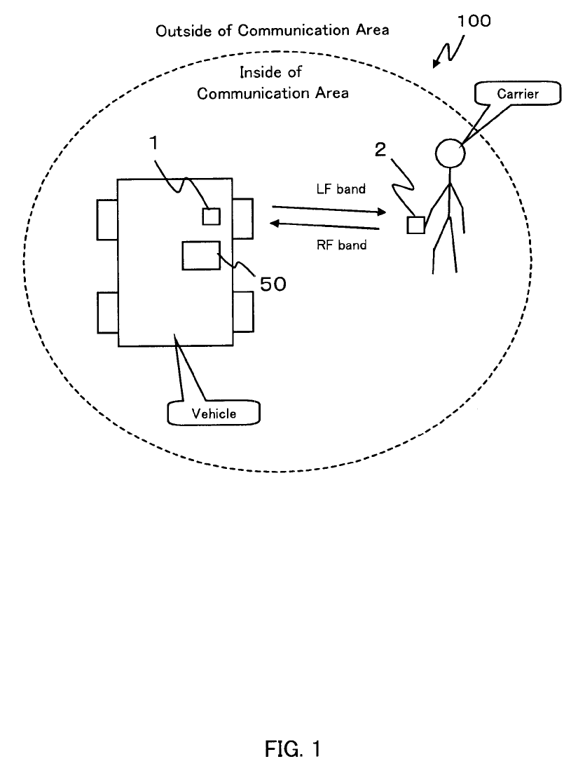

FIG. 1 illustrates schematically the configuration of the smart keyless entry system 100 of the present implementation. The smart keyless entry system 100 comprises a first radio communication device (hereinafter called a vehicle-mounted device 1) mounted in a vehicle and a second radio communication device (hereinafter called a mobile device 2) incorporated, e.g., in a key to be carried by a carrier such as the vehicle user. The vehicle-mounted device 1 is connected to an apparatus (hereinafter called a controller 50) that controls the locking/unlocking of the doors of the vehicle. In the smart keyless entry system 100 of the present implementation, the vehicle-mounted device 1 receives a signal transmitted from the mobile device 2 and controls the controller 50 according to the received signal, thereby automatically locking/unlocking the doors of the vehicle.

In the implementations described below, it is assumed that communication from the vehicle-mounted device 1 to the mobile device 2 is performed via ASK-modulated signals. As such, the ASK-modulation is used in communication from the vehicle-mounted device 1 to the mobile device 2, thereby simplifying the circuit configuration. Also, it is assumed that communication from the mobile device 2 to the vehicle-mounted device 1 is performed via FSK-modulated signals. As such, the FSK-modulation is used in communication from the mobile device 2 to the vehicle-mounted device 1, and thereby information can be transmitted with high quality from the mobile device 2 to the vehicle-mounted device 1 with suppressing the effects of noise. The modulation methods to be used in communication from the vehicle-mounted device 1 to the mobile device 2 and from the mobile device 2 to the vehicle-mounted device 1 are not limited to these. For example, other modulation methods such as spread spectrum modulation can be used.

In the implementations described below, it is assumed that a carrier wave of a frequency in a low frequency band (e.g., 125 kHz in a long wave (LF) band), whose strength is inversely proportional to the distance cubed, is used in communication from the vehicle-mounted device 1 to the mobile device 2 and has a communication distance of about 1 m, and that a carrier wave of a high frequency (e.g., 312 MHz in an ultrahigh frequency (UHF) band) is used in communication from the mobile device 2 to the vehicle-mounted device 1 and has a communication distance of about 5 to 20 m.

=First Implementation=

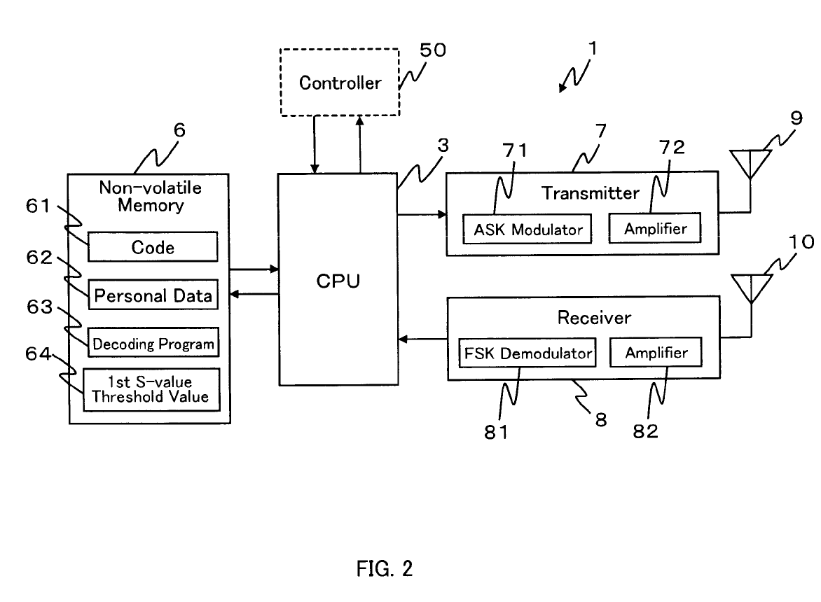

FIG. 2 illustrates the hardware configuration of the vehicle-mounted device 1 according to a first implementation of the present invention. The vehicle-mounted device 1 comprises a CPU 3, a non-volatile memory 6 such as a flash memory, a transmitter 7, a receiver 8, a transmit antenna 9, and a receive antenna 10.

The CPU 3 controls the constituents of the vehicle-mounted device 1 overall. Also, the CPU 3 executes programs stored in the non-volatile memory 6, thereby implementing various functions.

One of the above programs stored in the memory 6 to be executed by the CPU 3 is a decoding program 63 for decoding encrypted personal data received from the mobile device 2. Also, stored in the non-volatile memory 6 are a code 61 and personal data 62 to be used in authenticating data coming in from the mobile device 2 and a threshold value 64 (a first threshold value) for an S-value to be used in determining the distance between the vehicle-mounted device 1 and the mobile device 2.

The transmitter 7 comprises an ASK modulator 71 that outputs a transmit signal which a signal sent from the CPU 3 has been ASK-modulated (Amplitude Shift Keying Modulate) into with a carrier wave of low frequency (e.g. 125 kHz), an amplifier 72 that amplifies the transmit signal, and a transmit antenna 9 via which the amplified transmit signal is transmitted by radio.

The receiver 8 comprises a receive antenna 10 that receives radio signals, an amplifier 82 that amplifies the received signal from the receive antenna 10, and an FSK demodulator 81 that inputs a demodulated signal produced by demodulating the received, FSK-modulated (Frequency Shift Keying Modulate) signal to the CPU 3.

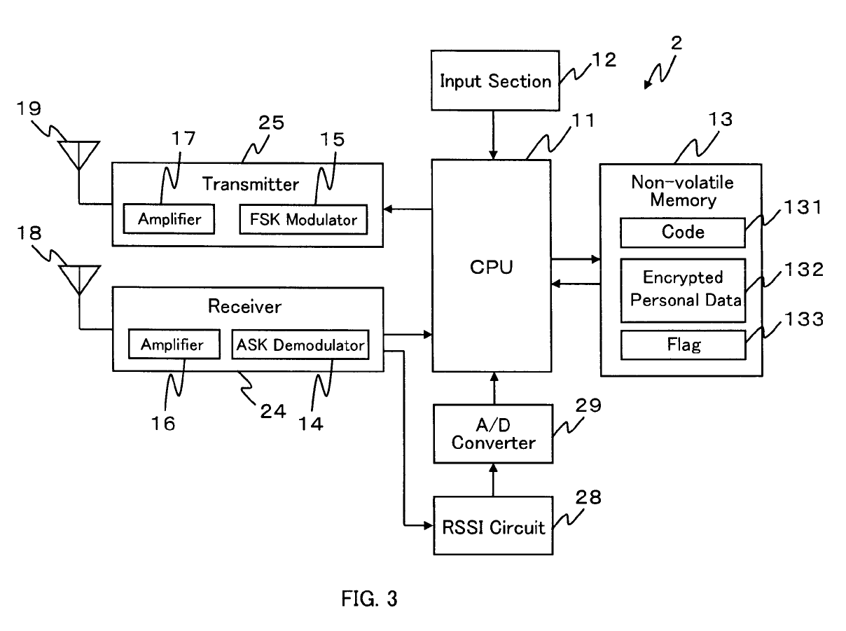

FIG. 3 illustrates the hardware configuration of the mobile device 2 according to the implementation of the present invention. The mobile device 2 comprises a CPU 11, an input section 12, a non-volatile memory 13 such as a flash memory, a receiver 24, a transmitter 25, a receive antenna 18, a transmit antenna 19, an RSSI circuit 28, and an A/D converter 29.

The CPU 11 controls the constituents of the mobile device 2 overall. Also, the CPU 11 executes programs stored in the non-volatile memory 13, thereby implementing various functions.

Stored in the non-volatile memory 13 are a code 131 and encrypted personal data 132, which are to be transmitted to the vehicle-mounted device 1 for authentication in this device, and a flag 133 indicating the content of the operation instruction inputted to the input section 12.

The transmitter 25 comprises an FSK modulator 15 that outputs a transmit signal which a signal sent from the CPU 11 has been FSK-modulated into with a carrier wave of high frequency (e.g., 312 MHz in an ultrahigh frequency (UHF) band), an amplifier 17 that amplifies the transmit signal, and a transmit antenna 19 via which the amplified transmit signal is transmitted by radio.

The receiver 24 comprises a receive antenna 18 via which radio signals are received, an amplifier 16 that amplifies the received signal input from the receive antenna 18, and an ASP, demodulator 14 that inputs a demodulated signal produced by demodulating the received, ASK-modulated signal to the CPU 11.

The input section 12 accepts the operation instruction input by the carrier to do an operation such as the lock/unlock operation of a specific door of the vehicle or the lock/unlock operation of all doors of the vehicle and inputs a signal that corresponds to the operation instruction input to the CPU 11.

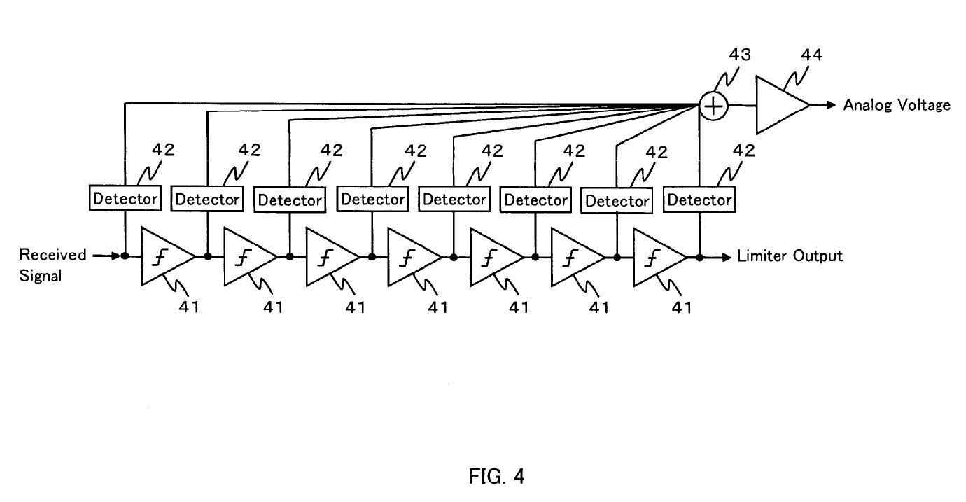

The RSSI (Received Signal Strength Indicator) circuit 28 (a signal strength measuring section) outputs in the form of an analog voltage the strength of the received signal input via the receive antenna 18 (hereinafter called an S-value). An AGC (Automatic Gain Control) voltage of the ASK demodulator 14, for example, is input to the RSSI circuit 28. FIG. 4 shows an example of the RSSI circuit 28. The RSSI circuit shown in the Figure comprises plural stages of limiter amplifiers 41, plural detectors 42 that detect the outputs of the respective limiter amplifiers 41, an adder 43 that adds the output voltages of the detectors 42, and an amplifier 44. The RSSI circuit outputs the sum of the respective output voltages of the detectors 42 in the form of the analog voltage indicating the signal strength.

The analog voltage indicating the signal strength output from the RSSI circuit 28 is converted by the A/D converter 29 into a digital value and supplied to the CPU 11.

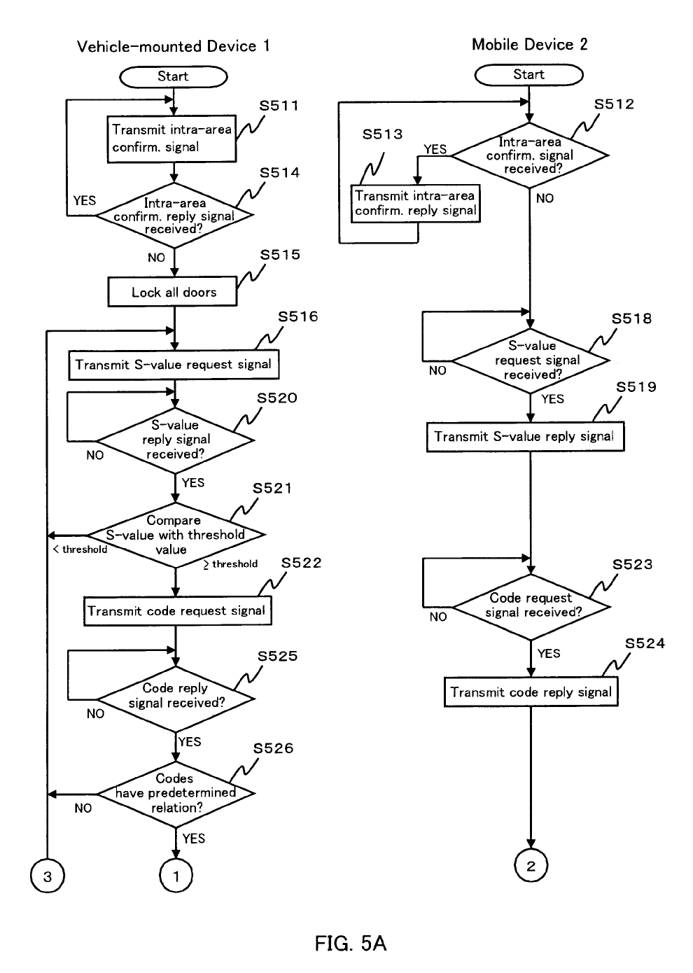

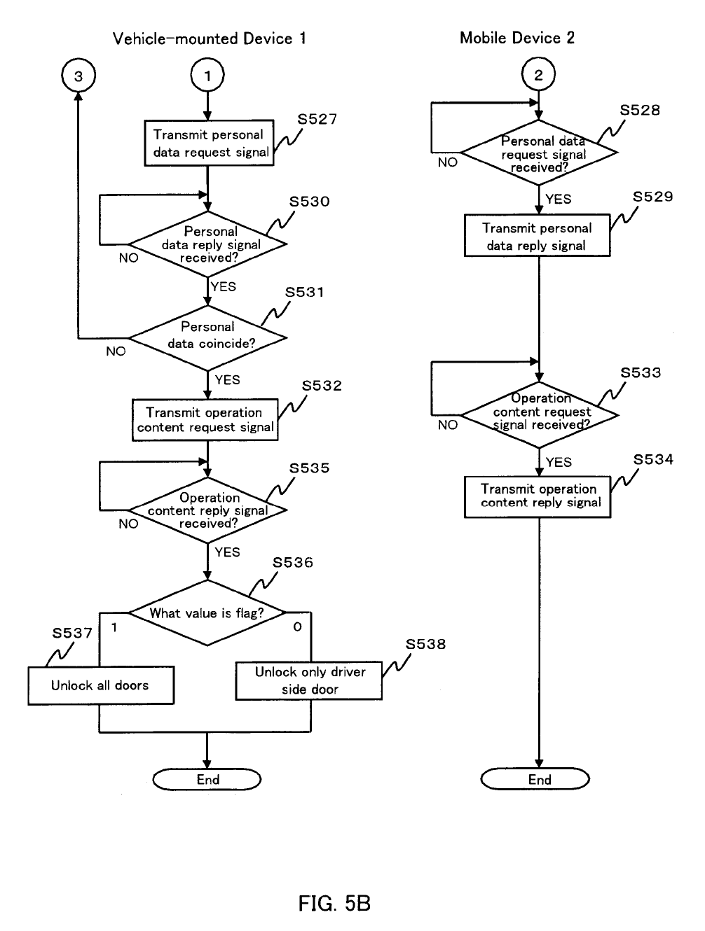

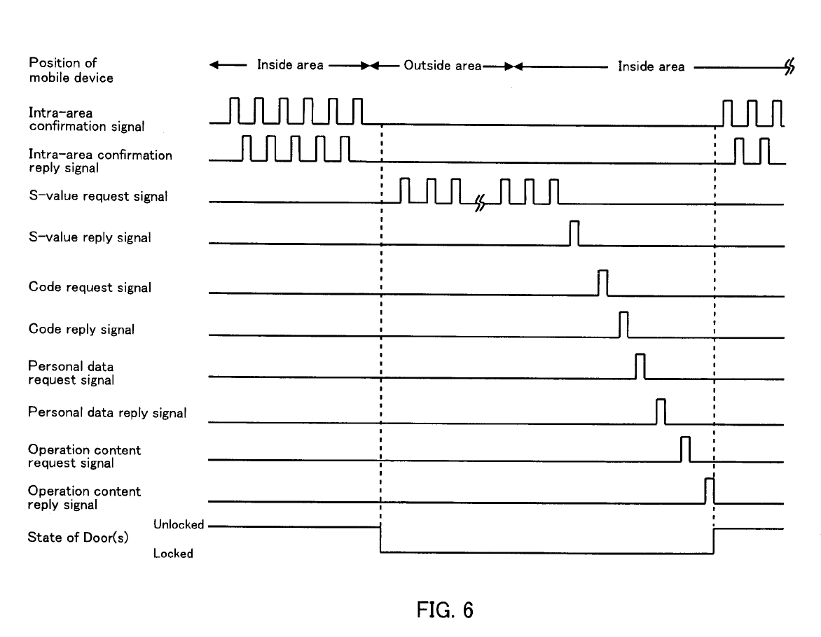

Next, the specific operation of the smart keyless entry system 100 according to the implementation of the present invention will be described with reference to the flow chart shown in FIGS. 5A and 5B and the timing chart shown in FIG. 6. Note that the flow chart shown in FIGS. 5A and 5B describes the process starting from the scene that after stopping the vehicle engine, the carrier carrying the mobile device 2 has got off the vehicle and just closed the door.

First, when the door is closed, the controller 50 detects that and inputs a signal indicating that to the CPU 3 of the vehicle-mounted device 1. When the signal is input, the CPU 3 of the vehicle-mounted device 1 controls the transmitter 7 to start transmitting a radio signal (fifth radio signal; hereinafter called an intra-area confirmation signal) to confirm whether the mobile device 2 is within a predetermined area (S511). Note that this intra-area confirmation signal is transmitted repeatedly at predetermined intervals thereafter. The intra-area confirmation signal (fifth radio signal) is a signal into which a carrier wave of a frequency in a low frequency band (e.g., 125 kHz in a long wave (LF) band) has been ASK-modulated.

Here, if the mobile device 2 is within the range in which it can receive the intra-area confirmation signal (hereinafter called a communication area), the mobile device 2 can receive the intra-area confirmation signal (fifth radio signal) transmitted from the vehicle-mounted device 1. The intra-area confirmation signal (fifth radio signal) received by the mobile device 2 is amplified by the amplifier 16 and demodulated by the ASK demodulator 14. The demodulated signal is input to the CPU 11.

The CPU 11 of the mobile device 2 monitors in real time whether the intra-area confirmation signal (fifth radio signal) has been input (S512). When detecting that the demodulated signal has been input (S512: YES), the CPU 11 of the mobile device 2 controls the transmitter 25 to transmit a radio signal (sixth radio signal; hereinafter called an intra-area confirmation reply signal) in reply to the intra-area confirmation signal (S513). The intra-area confirmation reply signal (sixth radio signal) is a signal into which a carrier wave of a frequency in a high frequency band (e.g., 312 MHz in an ultrahigh frequency (UHF) band) has been FSK-modulated.

When the mobile device 2 is within the communication area, the vehicle-mounted device 1 receives the intra-area confirmation reply signal (sixth radio signal) transmitted from the mobile device 2. The received intra-area confirmation reply signal (sixth radio signal) is amplified by the amplifier 82 of the vehicle-mounted device 1 and then demodulated by the FSK demodulator 81. The demodulated signal is input to the CPU 3. The CPU 3 of the vehicle-mounted device 1 monitors in real time whether the intra-area confirmation reply signal (sixth radio signal) has been input (S514). When detecting that the demodulated signal has been input (S514: YES), the CPU 3 of the vehicle-mounted device 1 controls the transmitter 7 to transmit the intra-area confirmation signal (fifth radio signal) again (S511).

As such, the vehicle-mounted device 1 monitors in real time whether the mobile device 2 is located within the communication area by detecting whether the intra-area confirmation reply signal (sixth radio signal) has been returned in reply to the transmitted intra-area confirmation signal (fifth radio signal). While it continues to determine that the mobile device 2 is within the communication area, the doors of the vehicle are unlocked.

If the intra-area confirmation reply signal (sixth radio signal) is not received within a predetermined time after transmitting the intra-area confirmation signal (fifth radio signal) (S514: NO), the vehicle-mounted device 1 inputs a signal to instruct to lock all doors of the vehicle to the controller 50 (S515). Instead of locking the doors immediately when it is determined that the intra-area confirmation reply signal (sixth radio signal) has not been received within the predetermined time, only when the intra-area confirmation reply signal (sixth radio signal) is not received while the intra-area confirmation signal (fifth radio signal) is transmitted a predetermined number of times, the doors of the vehicle may be locked. In this way, the vehicle-mounted device 1 can reliably determine that the mobile device 2 is not within the communication area. Furthermore, there may be cases where, immediately after going outside the communication area, the carrier returns inside the communication area, but in these cases, the carrier does not need to unlock the doors.

Next, the CPU 3 of the vehicle-mounted device 1 controls the transmitter 7 to transmit a signal to request the receive signal strength (S-value) (hereinafter called an S-value request signal) (S516). Note that the S-value request signal is transmitted at predetermined intervals. The S-value request signal is a signal into which a carrier wave of a frequency in a low frequency band (e.g., 125 kHz in a long wave (LF) band) has been ASK-modulated.

Next, when the mobile device 2 moves inside the communication area as the carrier approaches the vehicle again, the mobile device 2 receives the S-value request signal transmitted from the vehicle-mounted device 1 (S518). The S-value request signal received by the mobile device 2 is demodulated by the receiver 24. The demodulated signal is input to the CPU 11. At the same time, the AGC voltage output from the ASK demodulator 14 in the demodulation of the S-value request signal is input to the RSSI circuit 28, and the A/D converter 29 inputs digital data indicating the signal strength of the S-value request signal to the CPU 11.

After coming to be unable to receive the intra-area confirmation signal (fifth radio signal) (S512: NO), the CPU 11 of the mobile device 2 starts monitoring in real time whether the S-value request signal has been input (S518). When detecting that the S-value request signal has been input (S518: YES), the CPU 11 of the mobile device 2 controls the transmitter 25 to transmit a signal containing data indicating the signal strength of the S-value request signal (hereinafter called an S-value reply signal) (S519). The S-value reply signal is a signal into which a carrier wave of a frequency in a high frequency band (e.g., 312 MHz in an ultrahigh frequency (UHF) band) has, been FSK-modulated.

Next, the S-value reply signal is received by the vehicle-mounted device 1 and amplified by the amplifier 82 and then demodulated by the FSK demodulator 81. The demodulated signal is input to the CPU 3. The CPU 3 of the vehicle-mounted device 1 monitors in real time whether the S-value reply signal has been input (S520). When detecting that the S-value reply signal has been input (S520: YES), the CPU 3 of the vehicle-mounted device 1 compares the S-value contained in the demodulated signal with the threshold value 64 (first threshold value) for S-values stored in the non-volatile memory 6 (S521). Here, the first S-value threshold value 64 (first threshold value) is set to a value predetermined from a relationship, obtained via actual measurement, between the S-value and the distance between the vehicle-mounted device 1 and the mobile device 2 (e.g., an S-value measured when the distance is 1 m).

If the S-value contained in the demodulated signal is smaller than the first S-value threshold value 64 (first threshold value) (S521: being below the threshold), process returns to S516. On the other hand, if the S-value contained in the demodulated signal is at or above the first S-value threshold value 64 (first threshold value) (S521: being at or above the threshold), the CPU 3 controls the transmitter 7 to transmit a signal to request the sending of the code (hereinafter called a code request signal) to the mobile device 2 (S522). This code request signal is a signal into which a carrier wave of a frequency in a low frequency band (e.g., 125 kHz in a long wave (LF) band) has been ASK-modulated.

Then, the mobile device 2 receives the code request signal transmitted by the vehicle-mounted device 1. The code request signal received by the mobile device 2 is amplified by the amplifier 16 and demodulated by the ASK demodulator 14. The demodulated signal is input to the CPU 11. The CPU 11 of the mobile device 2 monitors in real time whether the code request signal has been input (S523). When detecting that the code request signal has been input (S523: YES), the CPU 11 of the mobile device 2 controls the transmitter 25 to transmit a signal containing the code 61 that has been stored in the non-volatile memory 13 (hereinafter called a code reply signal) (S524). The code reply signal is a signal into which a carrier wave of a frequency in a high frequency band (e.g., 312 MHz in an ultrahigh frequency (UHF) band) has been FSK-modulated.

The code reply signal is received by the vehicle-mounted device 1 and amplified by the amplifier 82 and then demodulated by the FSK demodulator 81. The demodulated signal is input to the CPU 3. The CPU 3 of the vehicle-mounted device 1 monitors in real time whether the code reply signal has been input (S525). When detecting that the code reply signal has been input (S525: YES), the CPU 3 of the vehicle-mounted device 1 determines whether the code contained in the demodulated signal and the code 61 stored in the non-volatile memory 6 have a predetermined relationship with each other (e.g., coinciding or being in a relationship where the value of one is calculated from the value of the other according to a predetermined function) (S526). If the two have a predetermined relationship (S526: YES), the CPU 3 of the vehicle-mounted device 1 controls the transmitter 7 to transmit a signal to request personal data (hereinafter called a personal data request signal) (S527). On the other hand, if the two do not have a predetermined relationship (S526: NO), process returns to S516, where the S-value request signal is transmitted again.

Then, the personal data request signal is received by the mobile device 2 and amplified by the amplifier 16 and then demodulated by the ASK demodulator 14. The demodulated signal is input to the CPU 11. The CPU 11 of the mobile device 2 monitors in real time whether the personal data request signal has been input (S528). When detecting that the demodulated signal has been input (S528: YES), the CPU 11 of the mobile device 2 controls the transmitter 25 to transmit a signal containing encrypted personal data 132 that has been stored in the non-volatile memory 13 (hereinafter called a personal data reply signal) (S529). The personal data reply signal is a signal into which a carrier wave of a frequency in a high frequency band (e.g., 312 MHz in an ultrahigh frequency (UHF) band) has been FSK-modulated.

Then, the personal data reply signal is received by the vehicle-mounted device 1. The received personal data reply signal is amplified by the amplifier 82 and then demodulated by the FSK demodulator 81. The demodulated signal is input to the CPU 3. The CPU 3 of the vehicle-mounted device 1 monitors in real time whether the personal data reply signal has been input (S530). When detecting that the personal data reply signal has been input (S530: YES), the CPU 3 of the vehicle-mounted device 1 decodes the encrypted personal data 132 contained in the demodulated signal and determines whether the decoded personal data and the personal data 62 stored in the non-volatile memory 6 coincide (S531). If the decoded personal data and the personal data 62 stored in the non-volatile memory 6 coincide (S531: YES), the CPU 3 of the vehicle-mounted device 1 controls the transmitter 7 to transmit a signal to request the content of the operation designated by the carrier (hereinafter called an operation content request signal) (S532). On the other hand, if the decoded personal data and the personal data 62 stored in the non-volatile memory 6 of the vehicle-mounted device 1 do not coincide (S531: NO), process returns to S516, where the S-value request signal is transmitted again.

Next, the mobile device 2 receives the operation content request signal. The received operation content request signal is amplified by the amplifier 16 and then demodulated by the ASK demodulator 14. The demodulated signal is input to the CPU 11. The CPU 11 of the mobile device 2 monitors in real time whether the operation content request signal has been input (S533). When detecting that the demodulated signal has been input (S533: YES), the CPU 11 of the mobile device 2 controls the transmitter 25 to transmit a signal containing the flag 133 that has been stored in the non-volatile memory 13 (hereinafter called an operation content reply signal) (S534).

The operation content reply signal is a signal into which a carrier wave of a frequency in a high frequency band (e.g., 312 MHz in an ultrahigh frequency (UHF) band) has been FSK-modulated. Assume that the flag 133 is set to 1 when the carrier designates the execution of the operation of unlocking the driver side door through the input section 12 and to 0 when the carrier designates the execution of the operation of unlocking all doors through the input section 12.

The operation content reply signal is received by the vehicle-mounted device 1. The received operation content reply signal is amplified by the amplifier 82 and then demodulated by the FSK demodulator 81. The demodulated signal is input to the CPU 3. The CPU 3 of the vehicle-mounted device 1 monitors in real time whether the operation content reply signal has been input (S535). When detecting that the operation content reply signal has been input (S535: YES), the CPU 3 of the vehicle-mounted device 1 examines the value of the flag 133 contained in the demodulated signal (S536). If the value of the flag 133 is at 1 (S536: 1), the CPU 3 of the vehicle-mounted device 1 inputs a signal to instruct to unlock only the driver side door of the vehicle to the controller 50. Thereby, only the driver side door of the vehicle is unlocked (S537). In contrast, if the value of the flag 133 is at 0 (S536: 0), the CPU 3 of the vehicle-mounted device 1 inputs a signal to instruct to unlock all doors to the controller 50. Thereby, all doors of the vehicle are unlocked (S538).

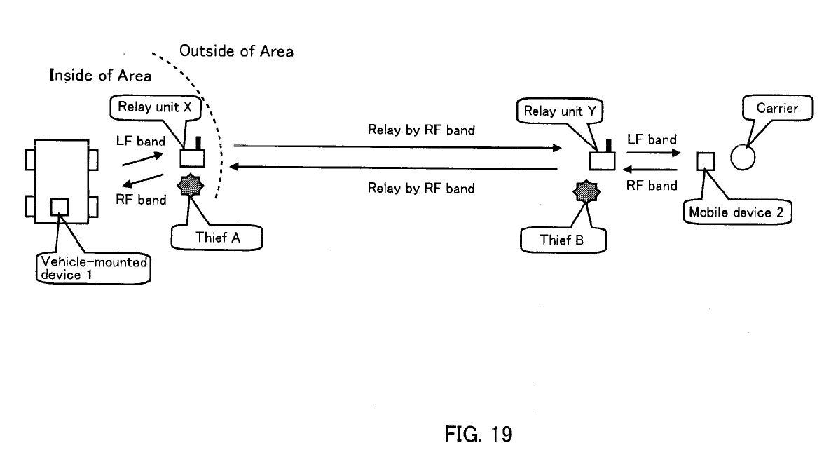

As such, the smart keyless entry system 100 of the implementation can reliably determine the distance between the vehicle-mounted device 1 and the mobile device 2 since determining the distance based on the S-value of the S-value request signal measured by the mobile device 2 side. Moreover, determining the distance between the vehicle-mounted device 1 and the mobile device 2 based on the S-value as above improves security against relay attacks. Consider, e.g., a case of a relay attack being made, in a situation where, as shown in FIG. 19, the mobile device 2 is located sufficiently away from the vehicle-mounted device 1 and a relay unit X involved in the relay attack is placed inside the communication area while a relay unit Y involved in the relay attack is placed near the mobile device 2 outside the communication area, by delivering the S-value request signal transmitted from the vehicle-mounted device 1 via the relay unit X to the mobile device 2 and then delivering the S-value reply signal returned from the mobile device 2 via the relay unit Y to the vehicle-mounted device 1. In this case, if the vehicle-mounted device 1 determines that an electric field strength (S-value) of the S-value request signal that the mobile device 2 received from the relay unit Y is below the first S-value threshold value 64 (first threshold value), the doors of the vehicle are not unlocked. That is, unless the relay unit Y is used in such a way as to satisfy the above condition to unlock, the relay attack cannot be achieved.

=Second Implementation=

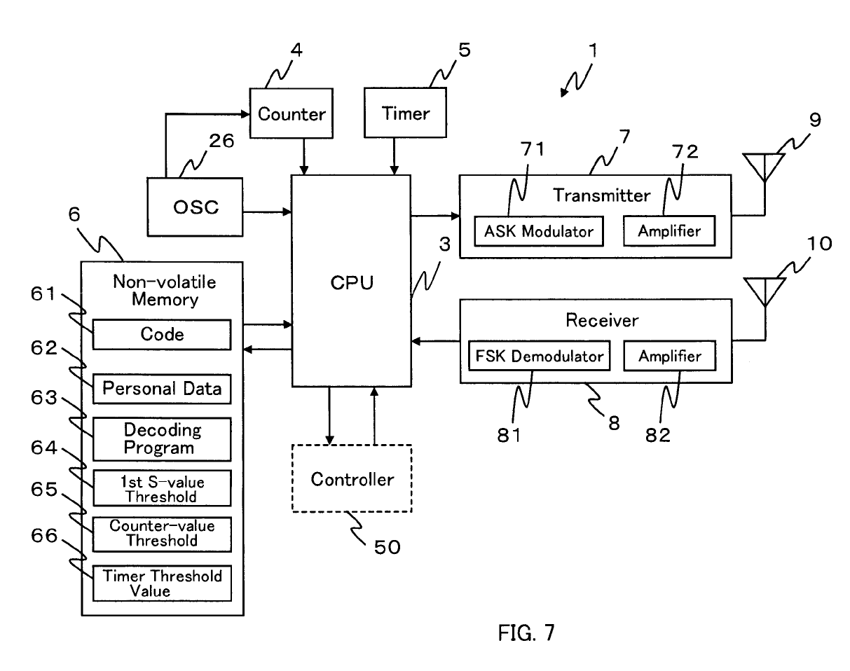

FIG. 7 illustrates the hardware configuration of the vehicle-mounted device 1 according to a second implementation of the present invention. The vehicle-mounted device 1 comprises a CPU 3, a non-volatile memory 6 such as a flash memory, a transmitter 7, a receiver 8, a transmit antenna 9, a receive antenna 10, and an OSC (Oscillator) 26. The configuration of the CPU 3, the non-volatile memory 6 such as a flash memory, the transmitter 7, the receiver 8, the transmit antenna 9, and the receive antenna 10 is the same as in the first implementation. The non-volatile memory 6 further stores a threshold value 65 (a second threshold value) for a counter value to be used in determining the distance between the vehicle-mounted device 1 and the mobile device 2.

The OSC 26 supplies a clock signal CLK0 of a predetermined frequency to the CPU 3.

A counter 4 counts the number of risings of the clock signal being supplied from the OSC 26 according to an instruction from the CPU 3. A timer 5 measures time according to an instruction from the CPU 3.

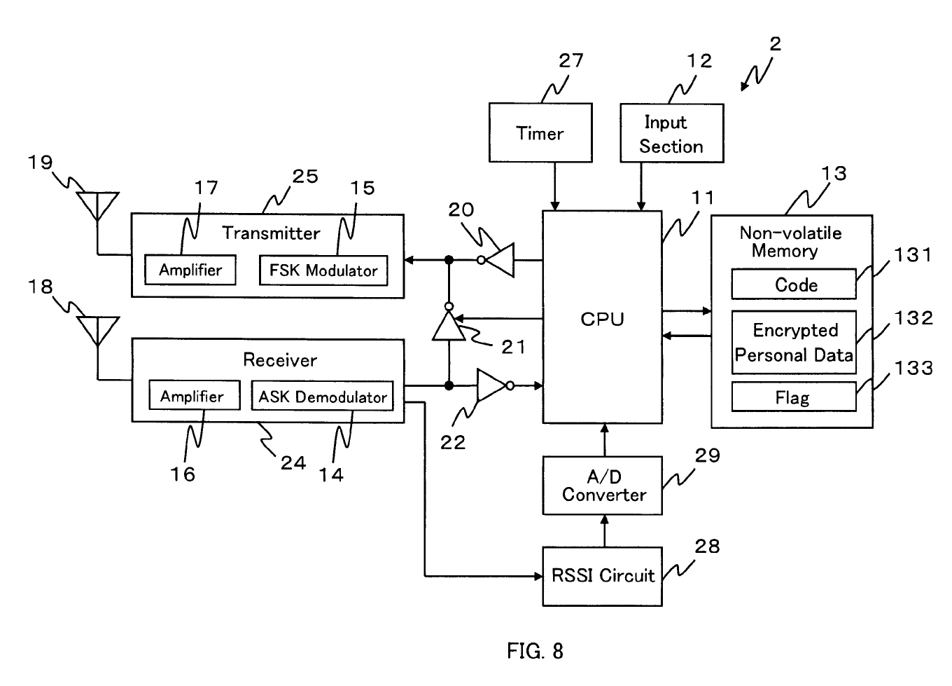

FIG. 8 illustrates the hardware configuration of the mobile device 2 according to the second implementation of the present invention. The mobile device 2 comprises a CPU 11, an input section 12, a non-volatile memory 13 such as a flash memory, a receiver 24, a transmitter 25, a receive antenna 18, a transmit antenna 19, inverters 20, 21, 22, a timer 27, an RSSI circuit 28, and an A/D converter 29. Of the configuration shown in the figure, the configuration of the CPU 11, the input section 12, the non-volatile memory 13 such as a flash memory, the receiver 24, the transmitter 25, the receive antenna 18, the transmit antenna 19, the RSSI circuit 28, and the A/D converter 29 is the same as in the first implementation.

The inverter 21 is controlled by the CPU 11 to switch on/off. By controlling the inverter 21, the mobile device 2 is switched into either an operation mode in which the demodulated signal from the receiver 24 is supplied to only the CPU 11 (hereinafter called a normal mode) or an operation mode in which the demodulated signal from the receiver 24 is supplied to the CPU 11 and via the inverter 21 to the transmitter 25 as well so that the transmitter 25 amplifies and returns the supplied demodulated signal (hereinafter called a return mode). The timer 27 measures time according to an instruction from the CPU 11.

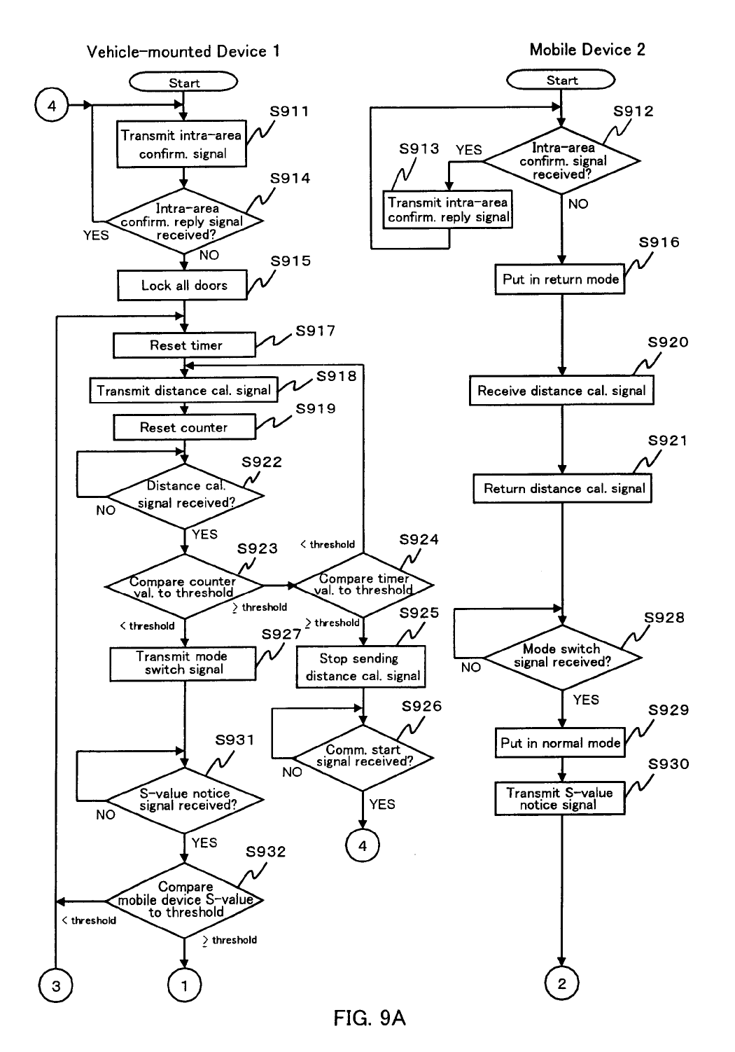

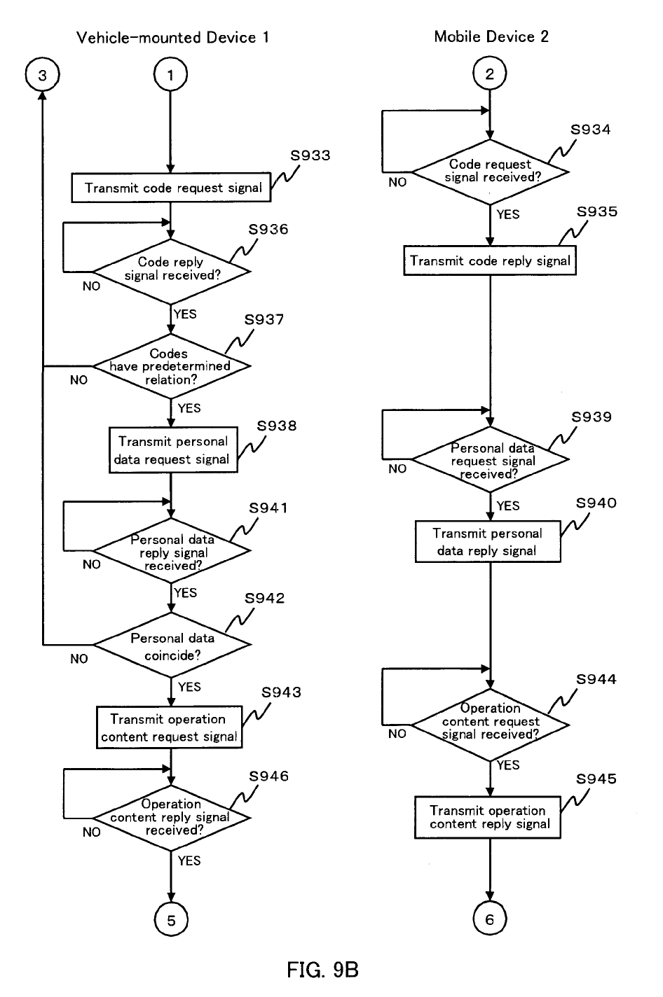

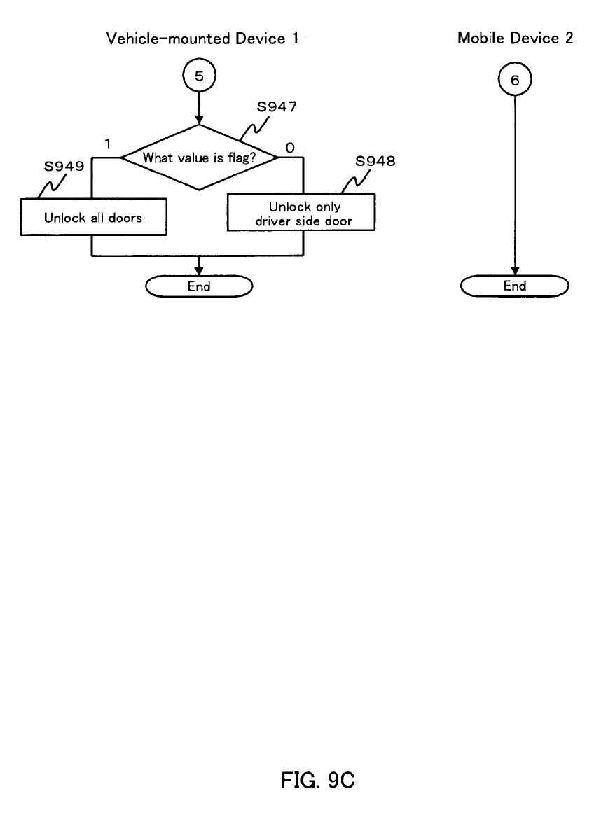

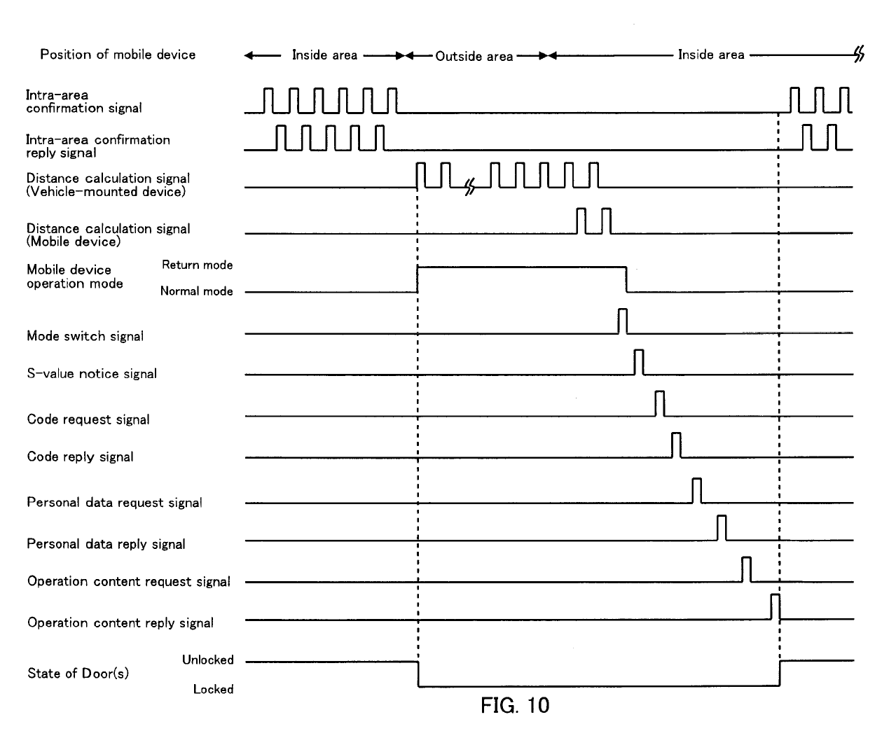

Next, the operation of the smart keyless entry system 100 according to the second implementation of the present invention will be described with reference to the flow chart shown in FIGS. 9A, 9B, 9C and the timing chart shown in FIG. 10. Of the flow chart shown in FIGS. 9A to 9C, the processes of S911 to S915 are the same as those of S511 to S515 in the first implementation. In the second implementation, after coming to be unable to receive the intra-area confirmation signal (fifth radio signal), the CPU 11 of the mobile device 2 controls the inverter 21 so as to put the mobile device 2 in the return mode (S916).

Then, the CPU 3 of the vehicle-mounted device 1 resets the timer 5 (S917), and thereby, the timer 5 starts to measure time. Also, the CPU 3 controls the transmitter 7 to transmit a radio signal (third radio signal; hereinafter called a distance calculation signal) to calculate the distance between the vehicle-mounted device 1 and the mobile device 2 (S918). Note that the distance calculation signal is transmitted at predetermined intervals. At the same time that it transmits the distance calculation signal (third radio signal), the CPU 3 resets and starts the counter 4 (S919), and thereby the counter 4 starts counting the number of risings of the clock signal. The distance calculation signal (third radio signal) is a signal into which a carrier wave of a frequency in a low frequency band (e.g., 125 kHz in a long wave (LF) band) has been ASK-modulated.

Next, when the mobile device 2 moves inside the communication area as the carrier approaches the vehicle again, the mobile device 2 receives the distance calculation signal (third radio signal) transmitted from the vehicle-mounted device 1 (S920). Here, since the mobile device 2 is in the return mode, the distance calculation signal (third radio signal) received by the mobile device 2 is supplied to the transmitter 25 via the inverter 21 and returned (S921). The distance calculation signal (fourth radio signal) is returned in the form of a signal into which a carrier wave of a frequency in a high frequency band (e.g., 312 MHz in an ultrahigh frequency (UHF) band) has been FSK-modulated.

The distance calculation signal (fourth radio signal) returned from the mobile device 2 and received by the vehicle-mounted device 1 is amplified by the amplifier 82 and then demodulated by the FSK demodulator 81. The demodulated signal is input to the CPU 3.

The CPU 3 of the vehicle-mounted device 1 monitors in real time whether the distance calculation signal (fourth radio signal) has been input (S922). When detecting that the distance calculation signal (fourth radio signal) has been input (S922: YES), the CPU 3 of the vehicle-mounted device 1 reads the counter value of the counter 4 at that time and compares the read counter value with the counter value threshold value 65 (second threshold value) stored in the non-volatile memory 6 (S923). Note that the counter value threshold value 65 (second threshold value) is set to a value predetermined from a relationship, obtained via actual measurement, between the counter value and the distance between the vehicle-mounted device 1 and the mobile device 2 (e.g., a counter value for when the distance is 1 m).

As such, by comparing the counter value read out from the counter 4 with the counter value threshold value 65 (second threshold value), the vehicle-mounted device 1 can determine whether the distance calculation signal received has been transmitted directly from the mobile device 2 or from a relay unit involved in the relay attack. That is, since the distance calculation signal (third radio signal) that is transmitted from the vehicle-mounted device 1 to the relay unit X and the distance calculation signal (third radio signal) that is relay-transmitted from the relay unit X to the mobile device 2 are each a signal into which a carrier wave of a frequency in a low frequency band has been modulated, they are slow in communication speed, and further, there is a sufficient distance between the vehicle-mounted device 1 and the mobile device 2. Hence, the transmission of the distance calculation signal (third radio signal) from the vehicle-mounted device 1 to the mobile device 2 takes a given time. Furthermore, since there is the sufficient distance between the vehicle-mounted device 1 and the mobile device 2, the transmission of the distance calculation signal (fourth radio signal) that is returned from the mobile device 2 and of the distance calculation signal (fourth radio signal) that is relay-transmitted from the relay unit Y to the vehicle-mounted device 1 takes a given time. Hence, a longer time is required from sending out the distance calculation signal by the vehicle-mounted device 1 to when the distance calculation signal from the mobile device 2 returns thereto than in normal communication without the relay units X, Y intervening. Thus, by comparing the counter value read out from the counter 4 with the counter value threshold value 65 (second threshold value), the vehicle-mounted device 1 can determine whether the distance calculation signal received (fourth radio signal) has been returned directly from the mobile device 2 or via the relay units X, Y.

If the counter value is at or above the counter value threshold value 65 (second threshold value), that is, the mobile device 2 is outside the communication area (S923: being at or above the threshold), then the CPU 3 of the vehicle-mcounted device 1 examines whether the timer value is at or above a timer threshold value 66 (S924). If the timer value is below the timer threshold value (S924: being below the threshold), process returns to S918, where the distance calculation signal (third radio signal) is transmitted again.

On the other hand, if the timer value is at or above the timer threshold value (S924: being at or above the threshold), the CPU 3 of the vehicle-mounted device 1 stops transmitting the distance calculation signal (third radio signal) (S925) and gets in a wait state of waiting to receive a communication start signal (S926). The communication start signal is a signal that is transmitted from the mobile device 2 by the carrier operating the input section 12 in a predetermined way. When the CPU 3 of the vehicle-mounted device 1 receives the communication start signal (S926: YES), process returns to S911.

In S923, if the counter value is below the counter value threshold value 65 (second threshold value), that is, the mobile device 2 is inside the communication area (S923: being below the threshold), then the CPU 3 of the vehicle-mounted device 1 controls the transmitter 7 to transmit a signal to put the mobile device 2 in the normal mode (hereinafter called a mode switch signal) (S927). The mode switch signal is a signal into which a carrier wave of a frequency in a low frequency band (e.g., 125 kHz in a long wave (LF) band) has been ASK-modulated.

The mode switch signal transmitted from the vehicle-mounted device 1 is received by the mobile device 2. The received mode switch signal is amplified by the amplifier 16 of the mobile device 2 and demodulated by the ASK demodulator 14. The demodulated signal is input to the CPU 11. The CPU 11 of the mobile device 2 monitors in real time whether the mode switch signal has been input (S928). When detecting that the demodulated signal has been input (S928: YES), the CPU 11 of the mobile device 2 puts the mobile device 2 in the normal mode (S929).

Next, the CPU 11 of the mobile device 2 controls the transmitter 25 to transmit a signal containing data indicating the signal strength of the S-value request signal (hereinafter called an S-value notice signal) output from the A/D converter 29 (S930). It may be that the S-value notice signal is not returned in response to receiving the mode switch signal but returned in response to receiving the S-value request signal transmitted from the vehicle-mounted device 1. The S-value notice signal is a signal into which a carrier wave of a frequency in a high frequency band (e.g., 312 MHz in an ultrahigh frequency (UHF) band) has been FSK-modulated.

The S-value notice signal is received by the vehicle-mounted device 1. The received S-value notice signal is amplified by the amplifier 82 and then demodulated by the FSK demodulator 81. The demodulated signal is input to the CPU 3. The CPU 3 of the vehicle-mounted device 1 monitors in real time whether the S-value notice signal has been input (S931). When detecting that the S-value notice signal has been input (S931: YES), the CPU 3 of the vehicle-mounted device 1 compares the S-value contained in the demodulated signal with the first S-value threshold value 64 (first threshold value) stored in the non-volatile memory 6 (S932). Here, the first S-value threshold value 64 (first threshold value) is set to a value predetermined from a relationship, obtained via actual measurement, between the S-value and the distance between the vehicle-mounted device 1 and the mobile device 2 (e.g., an S-value measured when the distance is 1 m).

If the S-value contained in the demodulated signal is smaller than the first S-value threshold value 64 (first threshold value) (S932: being below the threshold), process returns to S917. On the other hand, if the S-value contained in the demodulated signal is at or above the first S-value threshold value 64 (first threshold value) (S932: being at or above the threshold), the CPU 3 controls the transmitter 7 to transmit a signal to request the sending of the code (hereinafter called a code request signal) to the mobile device 2 (S933). The code request signal is a signal into which a carrier wave of a frequency in a low frequency band (e.g., 125 kHz in a long wave (LF) band) has been ASK-modulated.

The later processes by the vehicle-mounted device 1 and the mobile device 2 from receiving the code request signal by the mobile device 2 to unlocking the doors of the vehicle (processes of S934 and later) are the same as the processes of S525 and later in the first implementation.

As such, through determination based on a distance obtained on the basis of the S-value (hereinafter called first determination) and further through determination based on a distance obtained on the basis of the elapsed time from sending out the distance calculation signal (third radio signal) to receiving the distance calculation signal (fourth radio signal), the smart keyless entry system 100 of the implementation determines whether the mobile device 2 is within a predetermined distance from the vehicle-mounted device 1 (hereinafter called second determination), and determines the distance between the vehicle-mounted device 1 and the mobile device 2 based on results of the first and second determination. Thus, the distance between the vehicle-mounted device 1 and the mobile device 2 can be determined more reliably than is the case with determination based on only the S-value (only the first determination). Therefore, it can be reliably determined whether the distance calculation signal (fourth radio signal) received by the vehicle-mounted device 1 is returned directly from the mobile device 2 or via the relay units X, Y involved in the relay attack.

=Third Implementation=

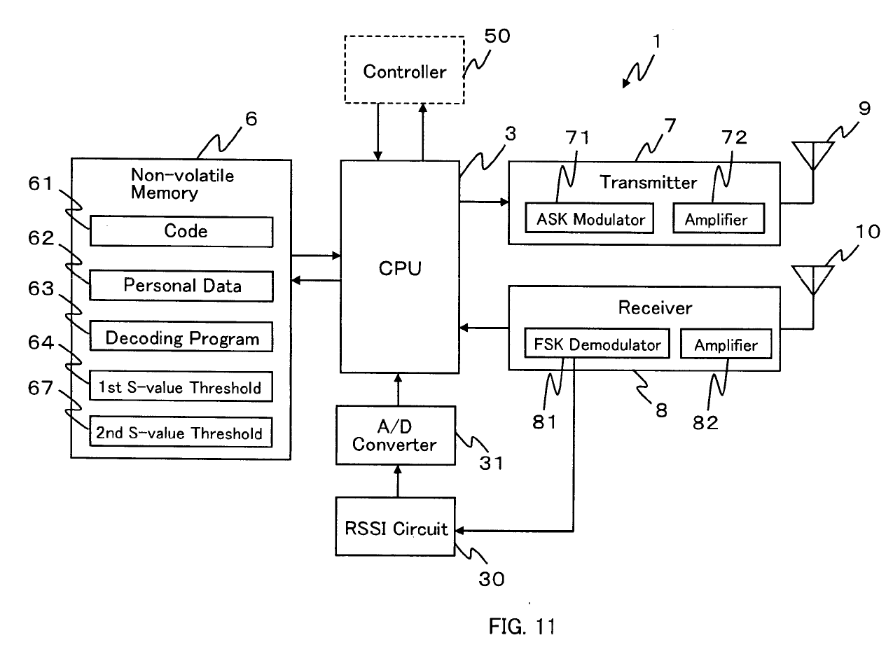

FIG. 11 illustrates the hardware configuration of the vehicle-mounted device 1 according to a third implementation of the present invention. The vehicle-mounted device 1 comprises a CPU 3, a non-volatile memory 6 such as a flash memory, a transmitter 7, a receiver 8, a transmit antenna 9, a receive antenna 10, an RSSI circuit 30 (a signal strength measuring section), and an A/D converter 31. The configuration of the CPU 3, the non-volatile memory 6 such as a flash memory, the transmitter 7, the receiver 8, the transmit antenna 9, and the receive antenna 10 is the same as in the first implementation. For example, the circuit shown in FIG. 4 is used as the RSSI circuit 30. The non-volatile memory 6 further stores a second threshold value 67 for S-values to be used in determining the distance between the vehicle-mounted device 1 and the mobile device 2.

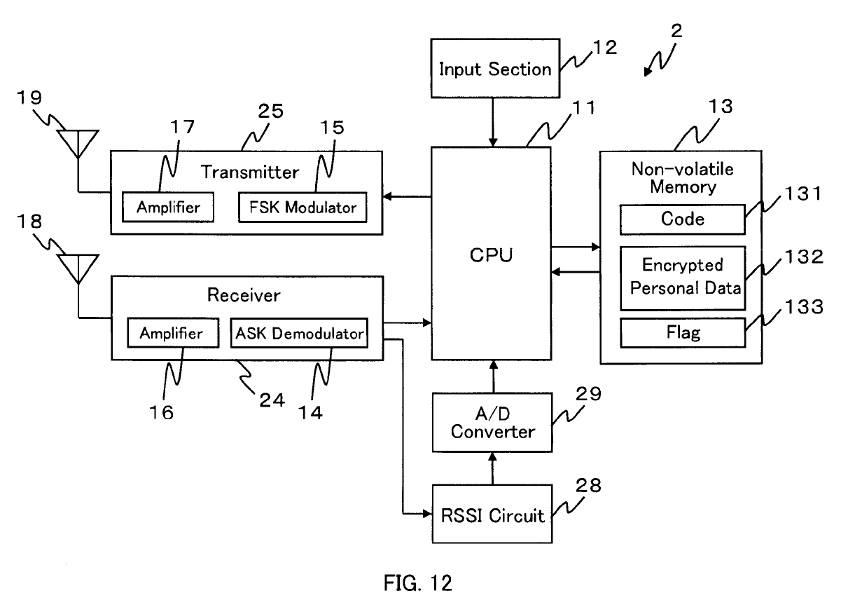

FIG. 12 illustrates the hardware configuration of the mobile device 2 according to the third implementation of the present invention. The mobile device 2 comprises a CPU 11, an input section 12, a non-volatile memory 13 such as a flash memory, a receiver 24, a transmitter 25, a receive antenna 18, a transmit antenna 19, an RSSI circuit 28, and an A/D converter 29. The configuration of them is the same as in the first implementation.

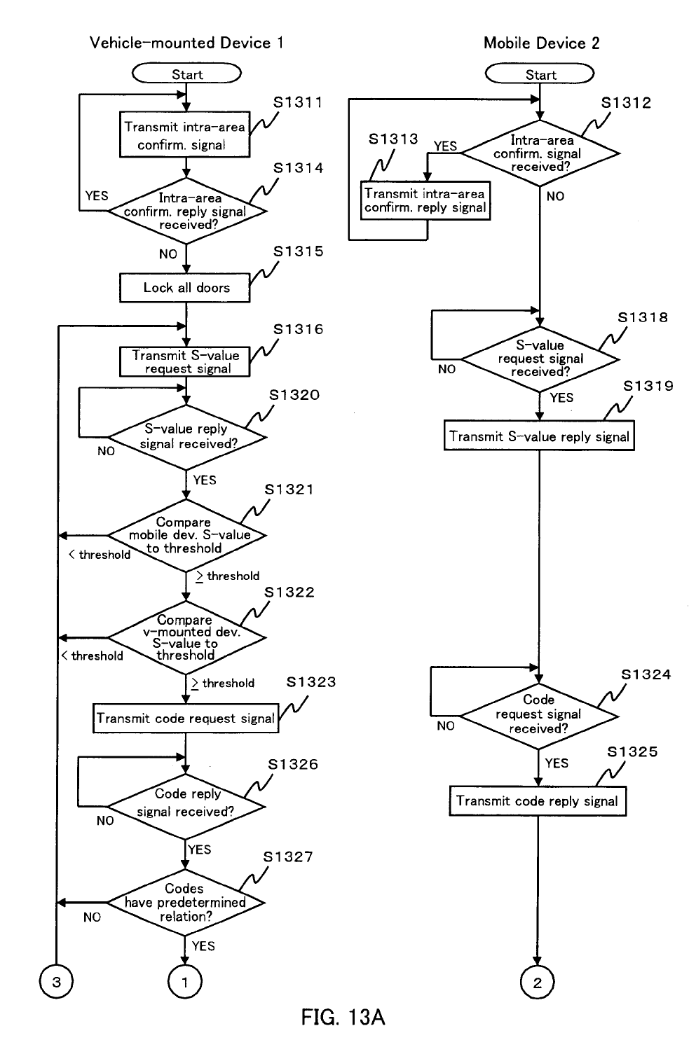

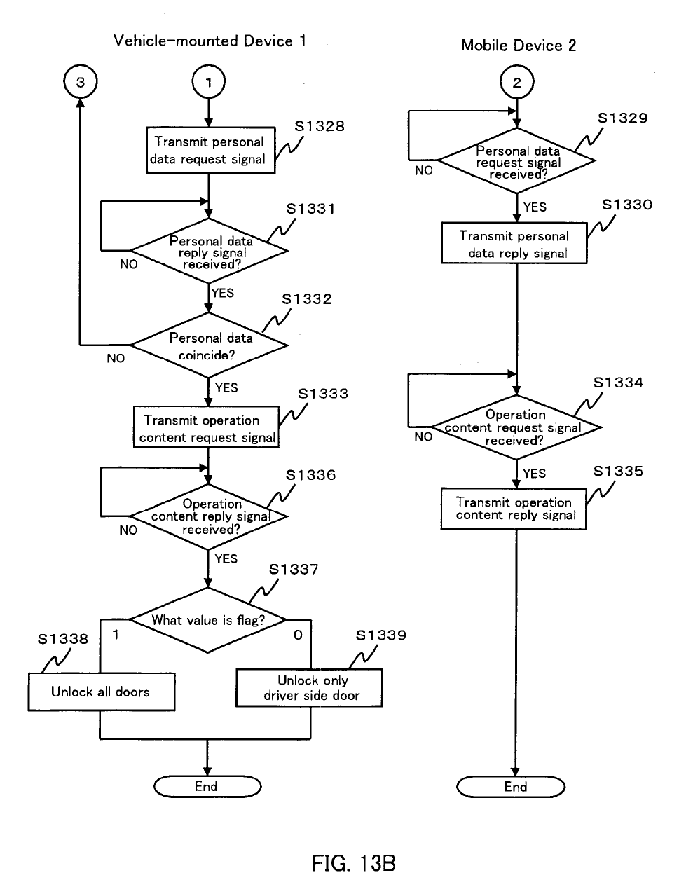

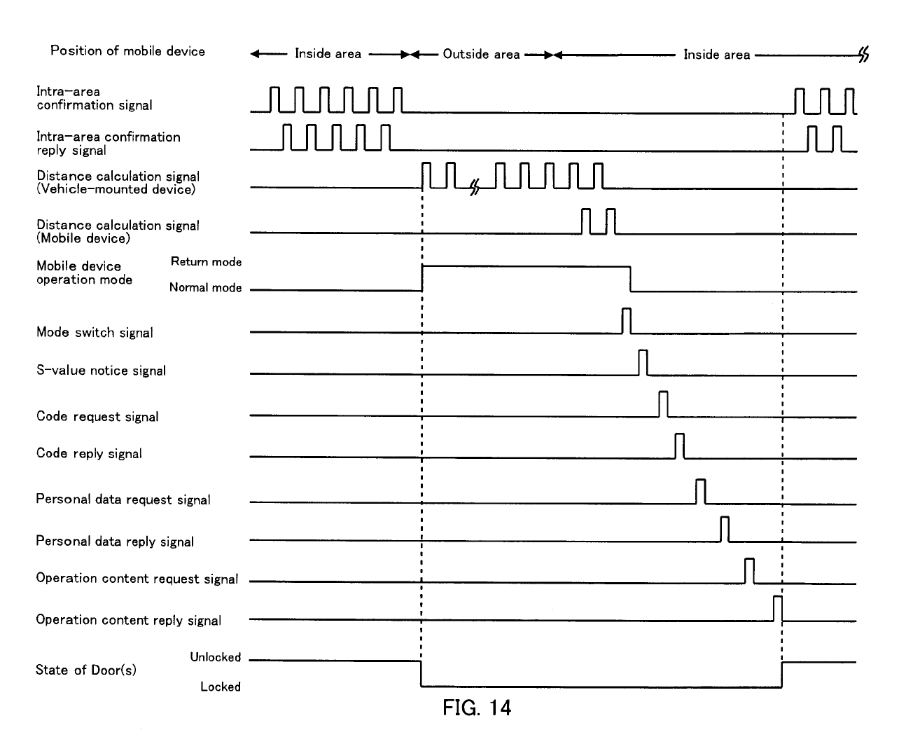

Next, the operation of the smart keyless entry system 100 according to the third implementation of the present invention will be described with reference to the flow chart shown in FIGS. 13A, 13B and the timing chart shown in FIG. 14. Of the flow chart shown in FIGS. 13A and 13B, the processes of S1311 to S1321 are the same as those of S511 to S521 in the first implementation. In the first implementation, by comparing an electric field strength (S-value) of the S-value request signal, transmitted from the vehicle-mounted device 1 to the mobile device 2, contained in the S-value reply signal transmitted from the mobile device 2 with the first S-value threshold value 64 (first threshold value), the distance between the vehicle-mounted device 1 and the mobile device 2 is determined (S521). However, in the third implementation, in addition to that determination, the vehicle-mounted device 1 measures an electric field strength (S-value) of the S-value reply signal transmitted from the mobile device 2 and compares this S-value with the second S-value threshold value 61 (third threshold value) stored in the non-volatile memory 6, thereby determining the distance between the vehicle-mounted device 1 and the mobile device 2 (S1322). Here, the second S-value threshold value 67 (third threshold value) is set to a value predetermined from a relationship, obtained via actual measurement, between the S-value and the distance between the vehicle-mounted device 1 and the mobile device 2 (e.g., an S-value measured when the distance is 1 m).

In the present implementation, the distance between the vehicle-mounted device 1 and the mobile device 2 is determined through both determination based on the S-value of the S-value request signal measured on the mobile device 2 side (hereinafter called first determination) and determination based on the S-value of the S-value reply signal measured on the vehicle-mounted device 1 side (hereinafter called second determination). Hence, the distance between the vehicle-mounted device 1 and the mobile device 2 can be more reliably determined. Furthermore, by determining double the distance between the vehicle-mounted device 1 and the mobile device 2, security against the relay attack is improved. For example, if the electric field strength (S-value) of the S-value request signal received by the mobile device 2 from the relay unit Y is at or above the first S-value threshold value 64, the doors of the vehicle are not unlocked. Also, if the electric field strength (S-value) of the S-value reply signal received by the vehicle-mounted device 1 from the relay unit X is at or above the second S-value threshold value 67, the doors of the vehicle are not unlocked. That is, unless both the relay units X, Y are used in such a way as to satisfy the above two conditions, the relay attack cannot be achieved, and thus relay attacks can be prevented more reliably.

The other processes by the vehicle-mounted device 1 and the mobile device 2 from receiving the code request signal by the mobile device 2 to unlocking the doors of the vehicle (processes of S1323 and later) are the same as the processes of S525 and later in the first implementation.

=Fourth Implementation=

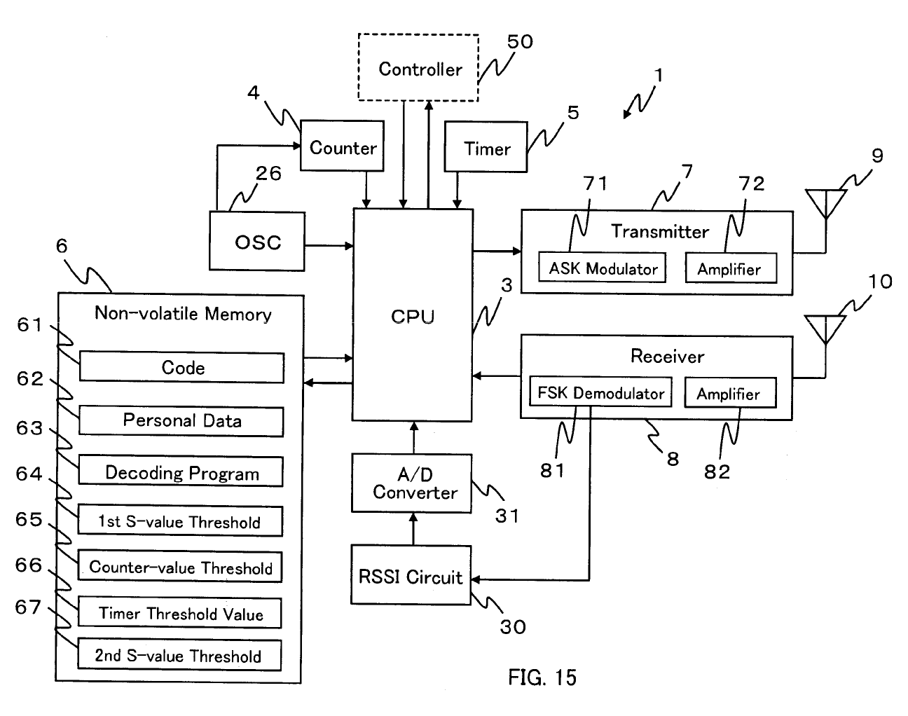

FIG. 15 illustrates the hardware configuration of the vehicle-mounted device 1 according to a fourth implementation of the present invention. The vehicle-mounted device 1 comprises a CPU 3, a counter 4, a timer 5, a non-volatile memory 6 such as a flash memory, a transmitter 7, a receiver 8, a transmit antenna 9, a receive antenna 10, an OSC 26, an RSSI circuit 30, and an A/D converter 31. The configuration of them is the same as in the first to third implementations.

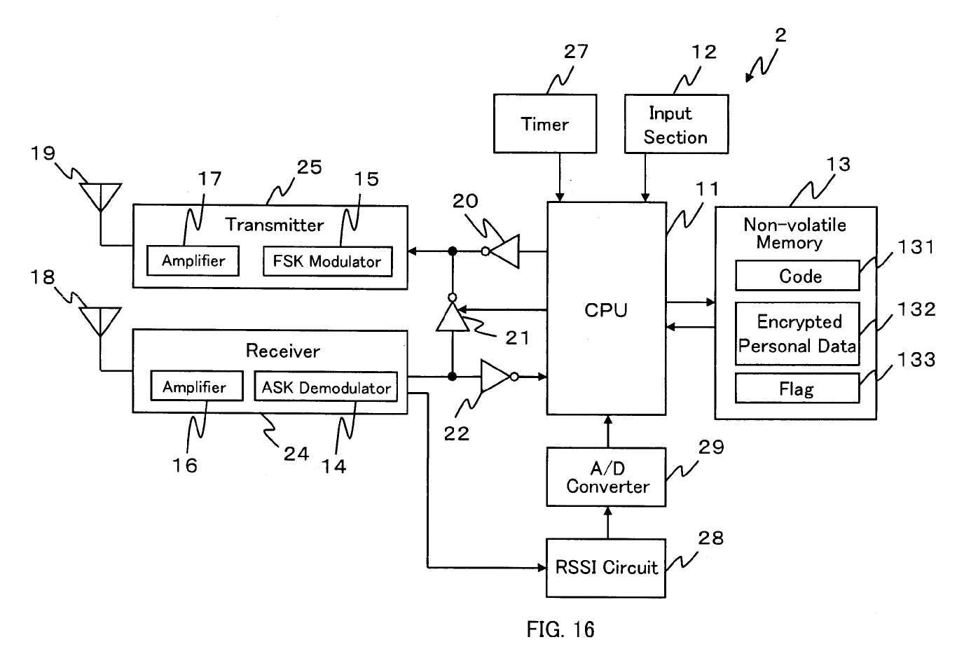

FIG. 16 illustrates the hardware configuration of the mobile device 2 according to the fourth implementation of the present invention. The mobile device 2 comprises a CPU 11, an input section 12, a non-volatile memory 13 such as a flash memory, a receiver 24, a transmitter 25, a receive antenna 18, a transmit antenna 19, inverters 20, 21, 22, a timer 27, an RSSI circuit 28, and an A/D converter 29. The configuration of them is the same as in the first to third implementations.

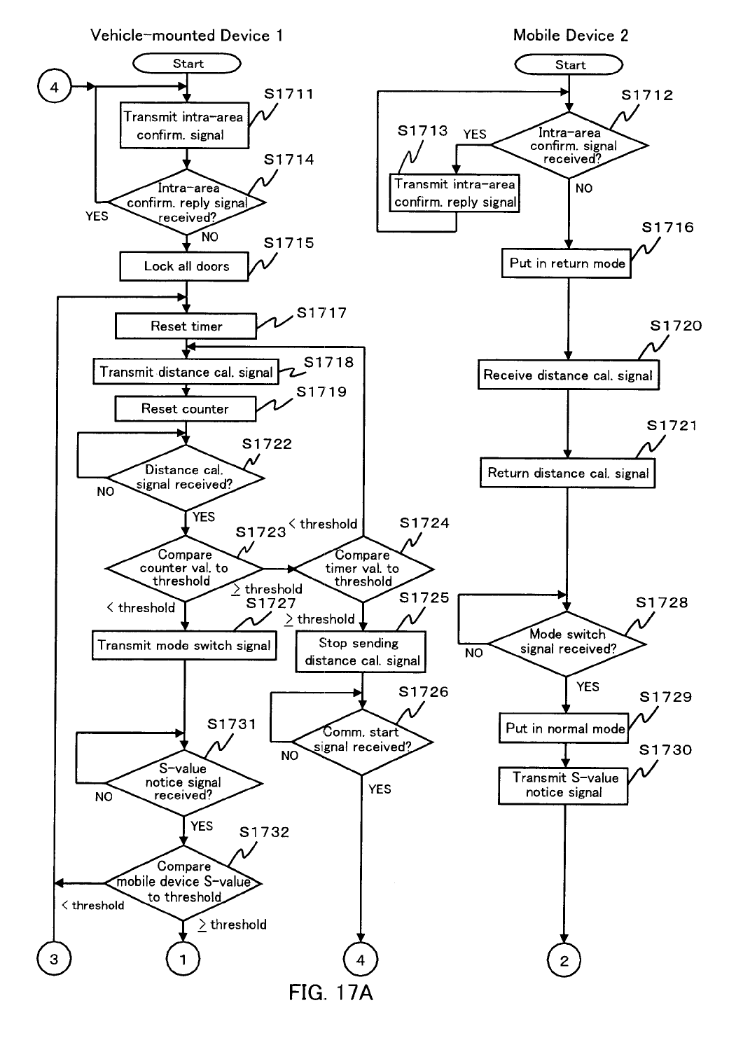

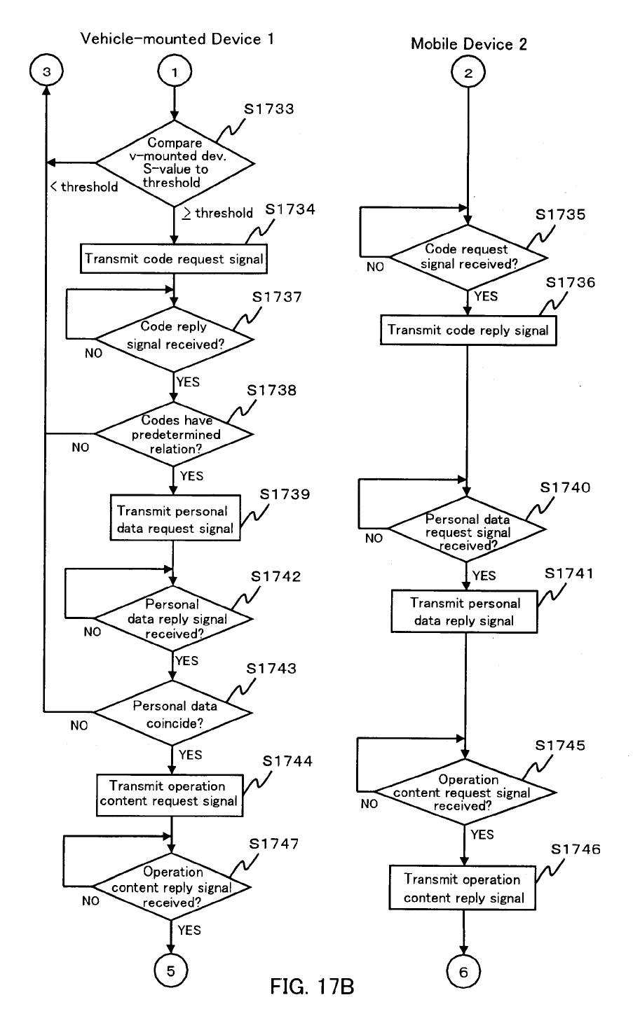

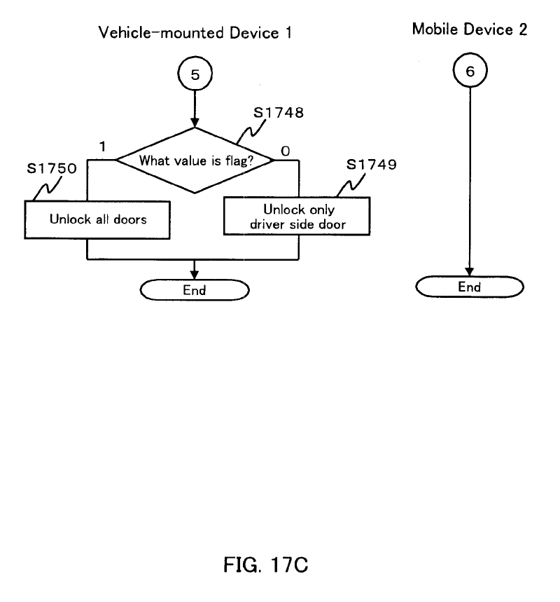

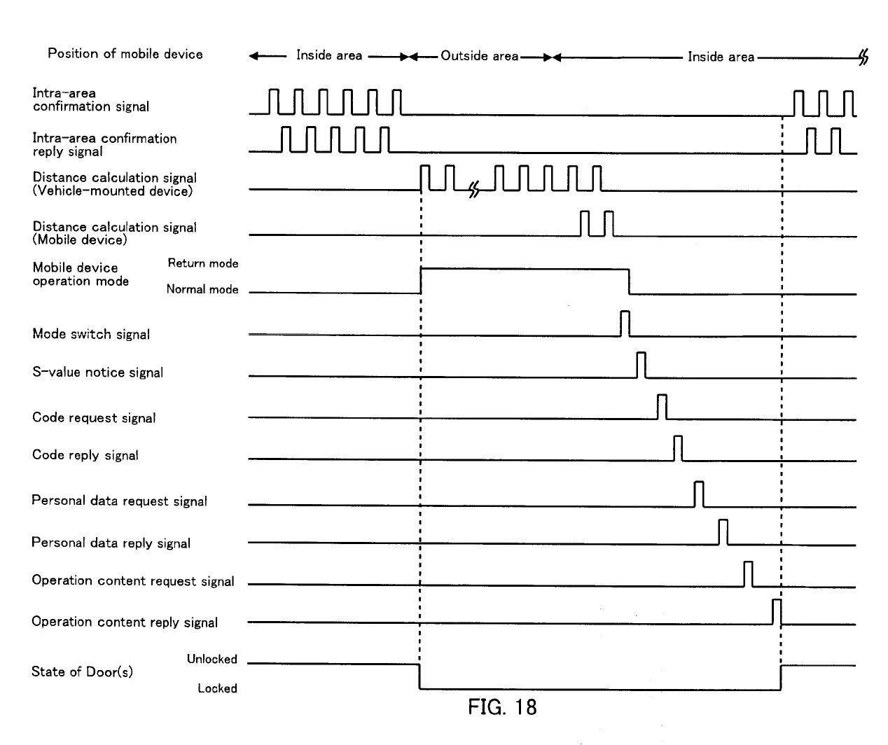

Next, the operation of the smart keyless entry system 100 according to the fourth implementation of the present invention will be described with reference to the flow chart shown in FIGS. 17A, 17B, 17C and the timing chart shown in FIG. 18. Of the flow chart shown in FIGS. 17A to 17C, the processes of S1711 to S1715 are the same as those of S511 to S515 in the first implementation. In the fourth implementation, in addition to the determination of the third implementation, determination of the distance based on the elapsed time from sending out the distance calculation signal by the vehicle-mounted device 1 to when the signal returned as in the second implementation is performed (S1733).

As such, the distance between the vehicle-mounted device 1 and the mobile device 2 is determined through determination based on the S-value of the S-value request signal measured on the mobile device 2 side (hereinafter called first determination), through determination based on the S-value of the S-value reply signal measured on the vehicle-mounted device 1 side (hereinafter called second determination), and determination based on the elapsed time from sending out the distance calculation signal by the vehicle-mounted device 1 to when the signal returned (hereinafter called third determination). Hence, the distance between the vehicle-mounted device 1 and the mobile device 2 can be more reliably determined. Furthermore, by determining triply the distance between the vehicle-mounted device 1 and the mobile device 2, relay attacks can be prevented more reliably.

The later processes by the vehicle-mounted device 1 and the mobile device 2 from receiving the code request signal by the mobile device 2 to unlocking the doors of the vehicle (processes of S1734 and later) are the same as the processes of S525 and later in the first implementation.

Although the preferred implementations of the present invention have been described, the above implementations are provided to facilitate the understanding of the present invention and not intended to limit the present invention. It should be understood that various changes and alterations can be made therein without departing from the spirit and scope of the invention and that the present invention includes its equivalents.

Although the above implementations have described example cases of applying the invention to the lock/unlock control of the doors of a vehicle, the invention can be applied to, for example, the start/stop control of the engine of a vehicle (ignition switch control). In this case, the vehicle-mounted device 1 may be connected to an apparatus that controls the start/stop of the engine of a vehicle, and receive a signal transmitted from the mobile device 2, determine based on the distance obtained from the S-value measured (first determination), and send the apparatus an instruction signal to start/stop the engine of the vehicle depending on the signal received by the vehicle-mounted device 1, thereby controlling the start/stop of the engine of the vehicle. Also, the invention can be applied to controls such as unlocking the steering lock mechanism of a vehicle and switching its accessory switch.

What is claimed is:

1. A radio communication system comprising:
a first radio communication device including a CPU; a memory; a transmitter that transmits a first radio signal; and a receiver that receives a second radio signal; and
a second radio communication device including a CPU; a memory; a transmitter that transmits the second radio signal; a receiver that receives the first radio signal; and a signal strength measuring section that measures a signal strength of the first radio signal, wherein
the first radio communication device transmits the first radio signal,
the second radio communication device receives the first radio signal,
the second radio communication device measures the signal strength of the first radio signal,
the second radio communication device transmits the second radio signal containing the signal strength measurement,
the first radio communication device receives the second radio signal, and
the first radio communication device performs first determination of a distance between the first and second radio communication devices based on the signal strength measurement contained in the received second radio signal.

2. A radio communication system comprising:
a first radio communication device including a CPU;
a memory; a transmitter that transmits a first radio signal; and a receiver that receives a second radio signal; and
a second radio communication device including a CPU; a memory; a transmitter that transmits the second radio signal; a receiver that receives the first radio signal; and a signal strength measuring section that measures a signal strength of the first radio signal, wherein
the first radio communication device transmits the first radio signal,
the second radio communication device receives the first radio signal,
the second radio communication device measures the signal strength of the first radio signal,
the second radio communication device transmits the second radio signal containing the signal strength measurement,
the first radio communication device receives the second radio signal,
the first radio communication device performs first determination of a distance between the first and second radio communication devices based on the signal strength measurement contained in the received second radio signal,
the first radio communication device transmits a third radio signal,
the second radio communication device receives the third radio signal,
the second radio communication device transmits a fourth radio signal in response to receiving the third radio signal,
the first radio communication device receives the fourth radio signal,
the first radio communication device performs second determination of the distance between the first and second radio communication devices based on an elapsed time from transmitting the third radio signal to receiving the fourth radio signal, and
the first radio communication device performs third determination of the distance between the first and second radio communication devices based on a result of the first determination and on a result of the second determination.

3. A radio communication system comprising:
a first radio communication device including a CPU; a memory; a transmitter that transmits a first radio signal; a receiver that receives a second radio signal; and a signal strength measuring section that measures a signal strength of the second radio signal; and
a second radio communication device including a CPU; a memory; a transmitter that transmits the second radio signal; a receiver that receives the first radio signal; and a signal strength measuring section that measures a signal strength of the first radio signal, wherein
the first radio communication device transmits the first radio signal,
the second radio communication device receives the first radio signal,
the second radio communication device measures the signal strength of the first radio signal,
the second radio communication device transmits the second radio signal containing the signal strength measurement,
the first radio communication device receives the second radio signal,
the first radio communication device performs first determination of a distance between the first and second radio communication devices based on the signal strength measurement contained in the received second radio signal,
the first radio communication device measures the signal strength of the received second radio signal,
the first radio communication device performs fourth determination of the distance between the first and second radio communication devices based on the measured signal strength of the second radio signal, and
the first radio communication device performs fifth determination of the distance between the first and second radio communication devices based on a result of the first determination and on a result of the fourth determination.

4. A radio communication system comprising:
a first radio communication device including a CPU; a memory; a transmitter that transmits a first radio signal; a receiver that receives a second radio signal; and a signal strength measuring section that measures a signal strength of the second radio signal; and
a second radio communication device including a CPU; a memory; a transmitter that transmits the second radio signal; a receiver that receives the first radio signal; and a signal strength measuring section that measures a signal strength of the first radio signal, wherein
the first radio communication device transmits the first radio signal,
the second radio communication device receives the first radio signal,
the second radio communication device measures the signal strength of the first radio signal,
the second radio communication device transmits the second radio signal containing the signal strength measurement,
the first radio communication device receives the second radio signal,
the first radio communication device performs first determination of a distance between the first and second radio communication devices based on the signal strength measurement contained in the received second radio signal,
the first radio communication device transmits a third radio signal,
the second radio communication device receives the third radio signal,
the second radio communication device transmits a fourth radio signal in response to receiving the third radio signal,
the first radio communication device receives the fourth radio signal,
the first radio communication device performs second determination of the distance between the first and second radio communication devices based on an elapsed time from transmitting the third radio signal to receiving the fourth radio signal,
the first radio communication device measures the signal strength of the received second radio signal,
the first radio communication device performs fourth determination of the distance between the first and second radio communication devices based on the measured signal strength of the second radio signal, and
the first radio communication device performs sixth determination of the distance between the first and second radio communication devices based on a result of the first determination, a result of the second determination and on a result of the fourth determination.

5. The radio communication system according to any one of claims 1 to 4, wherein the first radio communication device stores a first threshold value to be compared with the signal strength in the memory, and
wherein at the first determination, the first radio communication device compares the signal strength measurement contained in the received second radio signal with the first threshold value, thereby determining the distance between the first and second radio communication devices.

6. The radio communication system according to claim 2 or 4, wherein the first radio communication device stores in the memory a second threshold value to be compared with the elapsed time from transmitting the third radio signal to receiving the fourth radio signal, and
wherein at the second determination, the first radio communication device compares the elapsed time with the second threshold value, thereby determining the distance between the first and second radio communication devices.

7. The radio communication system according to claim 3, wherein the first radio communication device stores a third threshold value to be compared with the signal strength of the second radio signal in the memory, and
wherein at the fourth determination, the first radio communication device compares the measured signal strength of the second radio signal with the third threshold value, thereby determining the distance between the first and second radio communication devices.

8. The radio communication system according to claim 6, wherein the first radio communication device further comprises a counter, and starts the counter when transmitting the first radio signal, and
wherein at the second determination, the first radio communication device compares the value of the counter when receiving the second radio signal with the second threshold value as a counter value, thereby determining the distance between the first and second radio communication devices.

9. The radio communication system according to any one of claims 1 to 4, wherein the signal strength measuring section is constituted by an RSSI circuit.

10. The radio communication system according to claim 2 or 4, wherein the third radio signal is a signal into which a carrier wave of a frequency in a long wave band has been ASK-modulated.

11. The radio communication system according to claim 2 or 4, wherein the fourth radio signal is a signal into which a carrier wave of a frequency in an ultrahigh frequency band has been FSK-modulated.

12. The radio communication system according to claim 2 or 4, wherein the third radio signal is the same as the first radio signal, and the fourth radio signal is the same as the second radio signal.

13. The radio communication system according to claim 2 or 4, wherein the second radio communication device returns the received third radio signal as the fourth radio signal.

14. The radio communication system according to claim 2 or 4, wherein
the first radio communication device transmits repeatedly a fifth radio signal,
the second radio communication device receives the fifth radio signal, and
the second radio communication device transmits the fourth radio signal in response to receiving the third radio signal only when not being able to receive the fifth radio signal.

15. The radio communication system according to claim 14, wherein:
the second radio communication device transmits a sixth radio signal in response to receiving the fifth radio signal,
the first radio communication device receives the sixth radio signal, and
the first radio communication device transmits the fifth radio signal in response to receiving the sixth radio signal.

16. The radio communication system according to claim 2 or 4, wherein when determining at the second determination that the second radio communication device is not within a predetermined distance from the first radio communication device, the first radio communication device stops transmitting the third radio signal.

17. The radio communication system according to claim 1, wherein the first radio communication device is connected to a controller that controls locking or unlocking a door, and
wherein the first radio communication device transmits to the controller a signal to instruct to lock or unlock the door depending on a result of the first determination.

18. The radio communication system according to claim 2, wherein the first radio communication device is connected to a controller that controls locking or unlocking a door, and
wherein the first radio communication device transmits to the controller a signal to instruct to lock or unlock the door depending on a result of the third determination.

19. The radio communication system according to claim 3, wherein the first radio communication device is connected to a controller that controls locking or unlocking a door, and
wherein the first radio communication device transmits to the controller a signal to instruct to lock or unlock the door depending on a result of the fifth determination.

20. The radio communication system according to claim 4, wherein the first radio communication device is connected to a controller that controls locking or unlocking a door, and
wherein the first radio communication device transmits to the controller a signal to instruct to lock or unlock the door depending on a result of the sixth determination.

21. The radio communication system according to claim 1, wherein the first radio communication device is connected to a controller that controls starting or stopping an engine of a vehicle, and
wherein the first radio communication device transmits to the controller a signal to instruct to start or stop the engine of the vehicle depending on a result of the first determination.

22. The radio communication system according to claim 2, wherein the first radio communication device is connected to a controller that controls starting or stopping an engine of a vehicle, and
wherein the first radio communication device transmits to the controller a signal to instruct to start or stop the engine of the vehicle depending on a result of the third determination.

23. The radio communication system according to claim 3, wherein the first radio communication device is connected to a controller that controls starting or stopping an engine of a vehicle, and
wherein the first radio communication device transmits to the controller a signal to instruct to start or stop the engine of the vehicle depending on a result of the fifth determination.

24. The radio communication system according to claim 4, wherein the first radio communication device is connected to a controller that controls starting or stopping an engine of a vehicle, and
wherein the first radio communication device transmits to the controller a signal to instruct to start or stop the engine of the vehicle depending on a result of the sixth determination.

25. A radio communication device which is the first radio communication device of the radio communication system of claim 1, comprising:
a CPU; a memory; a transmitter that transmits a first radio signal; and a receiver that receives a second radio signal, the radio communication device
transmitting the first radio signal,
receiving the second radio signal, and
performing first determination of a distance between the first and second radio communication devices based on the signal strength measurement contained in the received second radio signal.

26. A radio communication device which is the second radio communication device of the radio communication system of claim 1, comprising:
a CPU; a memory; a transmitter that transmits a second radio signal; a receiver that receives a first radio signal; and a signal strength measuring section that measures a signal strength of the first radio signal, the radio communication device
receiving the first radio signal,
measuring a signal strength of the first radio signal, and
transmitting the second radio signal containing the signal strength measurement.

27. A radio communication device which is the first radio communication device of the radio communication system of claim 2, comprising:
a CPU; a memory; a transmitter that transmits a first radio signal; and a receiver that receives a second radio signal, the radio communication device
transmitting the first radio signal,
receiving the second radio signal,
performing first determination of a distance between the first and second radio communication devices based on the signal strength measurement contained in the received second radio signal,
transmitting a third radio signal,
receiving a fourth radio signal,
performing second determination of the distance between the first and second radio communication devices based on an elapsed time from transmitting the third radio signal to receiving the fourth radio signal, and
performing third determination of the distance between the first and second radio communication devices based on a result of the first determination and on a result of the second determination.

28. A radio communication device which is the second radio communication device of the radio communication system of claim 2, comprising:
a CPU; a memory; a transmitter that transmits a second radio signal; a receiver that receives a first radio signal; and a signal strength measuring section that measures a signal strength of the first radio signal, the radio communication device
receiving the first radio signal,
measuring a signal strength of the first radio signal,
transmitting the second radio signal containing the signal strength measurement,
receiving a third radio signal, and
transmitting a fourth radio signal in response to receiving the third radio signal.

29. A radio communication device which is the first radio communication device of the radio communication system of claim 3, comprising:
a CPU; a memory; a transmitter that transmits a first radio signal; a receiver that receives a second radio signal; and a signal strength measuring section that measures a signal strength of the second radio signal, the radio communication device
transmitting the first radio signal,
receiving the second radio signal,
performing first determination of a distance between the first and second radio communication devices based on the signal strength measurement contained in the received second radio signal,
measuring the signal strength of the received second radio signal,
performing fourth determination of the distance between the first and second radio communication devices based on the measured signal strength of the second radio signal, and
performing fifth determination of the distance between the first and second radio communication devices based on a result of the first determination and on a result of the fourth determination.

30. A radio communication device which is the first radio communication device of the radio communication system of claim 4, comprising:
a CPU; a memory; a transmitter that transmits a first radio signal; a receiver that receives a second radio signal; and a signal strength measuring section that measures a signal strength of the second radio signal, the radio communication device
transmitting the first radio signal,
receiving the second radio signal,
performing first determination of a distance between the first and second radio communication devices based on the signal strength measurement contained in the received second radio signal,
transmitting a third radio signal,
receiving a fourth radio signal,
performing second determination of the distance between the first and second radio communication devices based on an elapsed time from transmitting the third radio signal to receiving the fourth radio signal,
measuring the signal strength of the received second radio signal,
performing fourth determination of the distance between the first and second radio communication devices based on the measured signal strength of the second radio signal, and
performing sixth determination of the distance between the first and second radio communication devices based on a result of the first determination, a result of the second determination and on a result of the fourth determination.
